(19) United States
(12) Patent Application Publication
(10) Pub. No.: US 2020/0094443 A1
(43) Pub. Date: Mar. 26, 2020

(54) Method for Recycling Fiber-Reinforced Composite Materials

(71) Applicants: Schäfer Elektrotechnik u. Sondermaschinen GmbH, Rüssingen (DE); Carbon-Werke Weißgerber GmbH & Co. KG, Wallerstein (DE)

(72) Inventors: Ralf Schäfer, Rüssingen (DE); Franz Weißgerber, Wallerstein (DE)

(73) Assignees: Schäfer Elektrotechnik u. Sondermaschinen GmbH, Rüssingen (DE); Carbon-Werke Weißgerber GmbH & Co. KG, Wallerstein (DE)

(21) Appl. No.: 16/612,679

(22) PCT Filed: May 11, 2018
(86) PCT No.: PCT/EP2018/062249

§ 371 Date: Nov. 11, 2019

(30) Foreign Application Priority Data
May 11, 2017 (DE) 10 2017 110 281.7

(51) Int. Cl. B29B 17/04

(52) U.S. Cl. CPC B29B 17/0412; B29K 2105/06; B29B 2017/042

(57) ABSTRACT

The invention relates to a method for recycling fiber composite materials, in which items containing fiber composite material are fed into an impact reactor and comminuted by mechanical loading, wherein the comminution is carried out in such a way that fiber needles with adhering matrix are produced as the comminution product.

The invention relates to a method for reprocessing fibre composite materials, in which items containing fibre composite material are comminuted by mechanical loading.

Fibre composite materials contain a fibre material as an essential component. This is frequently present in the form of laminates, e.g. in the form of textiles, laid-up fabrics or mats. The fibre material is embedded into a matrix which frequently consists of a polymeric material, e.g. a thermoset material such as synthetic resin. Fibre composite materials are processed to form an extremely wide range of products and are used as moulded parts or structural components e.g. in ship-building and also in the aerospace industry. Furthermore, rotor blades for wind turbines frequently comprise structural components made from fibre composite materials.

Structural components produced from fibre composite materials have a limited service life. Thus by reason of e.g. material fatigue it is necessary to replace rotor blades of wind turbine installations after about 10 years. However, replacement is carried out earlier when rotor blades with different geometries are to be mounted. The large quantities of fibre composite materials give rise to the need to send the material for recycling.

However, in doing this, the use of a matrix of thermosetting material such as synthetic resin poses the problem that reversible melting of the matrix is not possible.

In this respect, items made from fibre composite material have thus far been comminuted e.g. in such a way that the fibre composite material is in the form of a powder. A method of this type is known e.g. from EP 0 473 990 A2. The product of the method, a powder, is then used as an additive for producing new moulded parts. In doing this, it is disadvantageous that the additive serves predominantly as a filler and does not lead to an improvement in the material properties.

The object of the invention is to develop a method for recycling fibre composite materials, the product of this method being comminution products which can be sent for high-grade re-use.

This object is achieved by the features of claim 1. The dependent claims refer to advantageous embodiments.

In the method in accordance with the invention for reprocessing fibre composite materials, items containing fibre composite material are fed into an impact reactor and comminuted by mechanical loading, wherein the comminution is carried out in such a way that fibre needles with adhering matrix are produced as the comminution product.

The comminution of items, i.e. products or components, containing fibre composite material in such a way that the comminution product is a powder has been known in the prior art for a long time. Alternatively attempts were made to completely separate the matrix from the fibres. However, the problem with this is that the coating with which the fibres are pre-treated in order to permit adhesion of the matrix is removed in so doing and must be re-applied. Furthermore, the method is very troublesome since the fibre material and matrix are very firmly bonded. It is also problematic that the fibres thus singularised no longer achieve the original strength of the original fibre material.

In contrast to the prior art method, in accordance with the invention it is desired that matrix adheres to the comminuted fibre material, the fibre needles. The product of the method, i.e. the comminution products, are consequently needle-like fibre items consisting of fibres or fibre bundles which are encased with matrix. In this respect, both the fibre material and also the matrix of the starting material are sent for recycling.

The method is preferably thus carried out in such a way that break edges with an irregular shape are produced on the fibre needles and improve the attachment of new matrix. Accordingly, the fibre composite is broken up during the comminution and fibre portions are singularised together with the matrix.

The comminution product preferably contains fibre needles with a fibre length of 0.1 mm to 20 mm. A fraction can also contain fibre needles with longer or shorter fibre lengths. The fibre length of 90 wt. % of a fraction of comminution products is preferably from 0.1 mm to 20 mm. In a particularly preferred manner, the comminution product contains fibre needles with a fibre length of 1 mm to 10 mm. From a fraction of items which are comminuted in the impact reactor, fibre needles with adhering matrix in different fibre lengths are produced, wherein the fibre length is from 1 mm to 10 mm. The comminution product is free-flowing and can be processed in a mixer. In this respect, the comminution product, the fibre needles, can be further processed by simple means.

The starting material, the items to be comminuted, contain about 30 wt. % to wt. % of matrix and 60 wt. % to 70 wt. % of fibres.

New moulded parts can be produced from fibre needles of the above-mentioned length, wherein random orientation of the fibre needles and uniform distribution of fibre needles of different lengths produce, on the one hand, an isometric strength behaviour and, on the other hand, a surprisingly high level of strength in the newly produced moulded part. In this respect, the reprocessed fibre material in the form of fibre needles can be sent for high-grade re-use.

A grading curve can be determined in relation to a quantity of comminution products by means of mesh analysis. In so doing, it is feasible e.g. to carry out a mesh analysis in each case in relation to a fraction of items to be comminuted and to determine the grading curve for the comminuted fraction.

The grading curve shows the distribution of the fibre lengths of the comminuted fibre needles of the comminuted fraction. It is thereby possible to establish the fibre length distribution of the comminution products of the comminuted fraction.

By mixing different fractions which have different grading curves it is therefore possible to produce a preset fibre length distribution for a quantity of comminution products. This renders possible the production of moulded parts with uniform product properties. Furthermore, it is feasible to specify different formulations for different application purposes, these formulations being intended to have a particular fibre length distribution. This can be achieved by controlled mixing of fractions of comminution products which have a different fibre length distribution.

An advantageous impact reactor has a cylindrical casing which is provided on one end face with a floor and on the other end face with a cover. The floor is allocated a rotatably mounted impact body. The cylindrical casing, the floor and the cover define an impact reactor chamber. The cover is provided with an opening for receiving the items. The impact body can include chains or be formed as a rotor which is provided with impact elements.

Ejection openings can be disposed in the peripheral region of the impact reactor. In so doing, the ejection openings are preferably allocated to the casing. The ejection openings can be closable by means of flaps. The ejection openings permit the discharging of the comminution products.

The ejection openings are preferably designed in such a way that the comminution product can be discharged continuously from the impact reactor. In doing this, it is advantageous that the dwell time of the fibre composite material in the impact reactor chamber is only very brief and so the mechanical effect caused by the impact body is limited. The comminution products are discharged when the desired fibre length is achieved. In doing this, it is advantageous that a large part of the matrix still adheres to the fibres and that the fibre needles forming the comminution product have sharp and irregular break edges, which improves the attachment of new matrix.

The ejection openings can be covered with slotted or perforated cover plates. The slotted or perforated cover plates permit, on the one hand, continuous output of the comminution products and, on the other hand, an output of the comminution products as soon as these have reached the desired fibre length. On the one hand, the dwell time of the fibre composite material in the impact reactor is consequently very short and, on the other hand, fibre needles with a long fibre length can be discharged out of the impact reactor.

In this respect, continuous discharge of comminuted material takes place during comminution of the items. The comminution products leave the impact reactor as soon as they have been comminuted to such a degree that they pass through the cover plates.

The selection of the cover plates can be modified in dependence upon a mesh analysis previously carried out. In so doing, the cover plates can be selected, e.g. with respect to diameter and geometry of the through-openings, in such a way that fibre needles with a desired fibre length distribution can be discharged from the impact reactor.

Cover plates with differently dimensioned through-openings can be provided. In this way fibre needles can be separated in dependence upon the fibre length even during discharge of the fibre needles out of the impact reactor.

If it is desirable to carry out further comminution the cover plates can be closed by cover flaps.

In addition to the cover plates, ejection flaps for ejecting large parts can be provided. This is particularly advantageous when composite materials with material combinations are processed in the impact reactor. If the composite material contains both metal portions and also fibre composite material, the fibre composite material is continuously discharged from the impact reactor during comminution in the form of the fibre needles. The metal portions can then be removed via the ejection flap.

A classifying device can be allocated to the impact reactor. This can be attached directly to the ejection opening. The classifying device can comprise screens which permit sorting of the comminution products according to fibre length. In this respect, after exit of the comminution products out of the ejection opening, a mesh analysis can be carried out or the fibres can be sorted according to fibre length. This permits advantageous grouping of fibres with a specific fibre length. The advantageous selected fibre length distribution can also be achieved by the above-described selection of the cover plates. In this way, particularly high-grade new moulded parts can be produced therefrom.

The fibre material can contain glass fibres, carbon fibres, basalt fibres and/or aramid fibres. Although fibre composite materials produced from glass fibres or basalt fibres are inexpensive, they are also found in particularly high numbers. Fibre composite materials produced from carbon fibres are particularly cost-intensive and difficult to process. By reason of the high level of strength, the reprocessing of such fibre composite materials has been difficult thus far. However, it has been demonstrated that moulded bodies produced from the fibre needles have very good material properties, in particular when the fibre needles include carbon fibres. The fibre needles forming the comminution product thus consist of bundles of carbon fibres to which matrix adheres.

In order that a firm composite of matrix and fibre can be produced, fibres are provided with a size. In this respect, e.g. glass fibres are provided with glass fibre sizes and carbon fibres with carbon fibre sizes. The sizes are deposited in the form of a coating on the fibres and improve the adhesion with respect to the matrix. The fibre needles produced by the method in accordance with the invention contain fibres with adhering size and adhering matrix. In this respect, it is not necessary to provide the fibre needles again with a size. The fibre needles can embed directly into a new matrix and be further processed to form a moulded part. Owing to the fact that the original size adheres to the fibres, a firm attachment of the new matrix to the fibres is ensured. In this way, moulded parts with surprisingly high strength values are produced even though recycled fibre material is being used.

The items can be sent for pre-comminution prior to comminution in the impact reactor. By reason of the pre-comminution block-like items which can be introduced into an impact reactor can be produced from large moulded parts, e.g. from rotor blades of wind turbine installations. The pre-comminution can be effected e.g. by sawing or waterjet cutting. The items produced by the pre-comminution can then be transported by conventional conveying devices, such as e.g. conveyor belts, and are free-flowing.

According to one advantageous embodiment the comminution product can be mixed with new matrix and processed to form moulded parts. The fibre needles which are produced by the method in accordance with the invention are stirrable and can be processed e.g. in a conventional stirrer or mixer. By determining the grading curve it is possible to provide a fibre composition with a specific fibre length distribution and so moulded parts with desired mechanical properties can be produced.

A moulded body in accordance with the invention contains fibre needles which can be obtained by the above-described method, and matrix. The matrix is preferably formed from thermosetting material, e.g. a synthetic resin. For this purpose, fibre needles are mixed with liquid matrix and processed to form a moulded part, e.g. sheet goods. The further processing takes place e.g. by pressing and by the effect of heat. The matrix thus hardens and a firm composite of fibre needles and matrix is formed. The fibre needles can have a pre-selected fibre length distribution. The selection of fibre needles can be effected by means of mesh analysis carried out previously.

By mixing the fibres with the matrix and further processing in a press, a uniform distribution and orientation of the fibre needles is achieved. In this way, the newly produced moulded part has isometric strength properties. By using fibre needles of different fibre lengths, shorter fibre needles can be attached in intermediate spaces between longer fibre needles. Furthermore, pulverulent comminution products which can likewise result from the comminution in accordance with the invention can also be processed. In doing this, it is advantageous that the dense arrangement of the fibre needles results in a mechanically strong composite and that only a small quantity of new matrix is required to produce moulded parts.

Prior to comminution, the starting product has about 30 wt. % to 40 wt. % of matrix and 60 wt. % to 70 wt. % fibre material. The moulded part newly produced from the comminuted fibre needles has about 45 wt. % to 55 wt. %, preferably 50 wt. % of matrix. In this respect, the new moulded part contains a relatively small quantity of newly added matrix. The quantity of the newly added matrix amounts to merely 10 wt. % to 20 wt. %. In this respect, the moulded part produced from fibre needles still has a very high proportion of fibres, leading to a high level of strength.

The method in accordance with the invention is explained in more detail hereinunder with the aid of the FIGURE which schematically shows in:

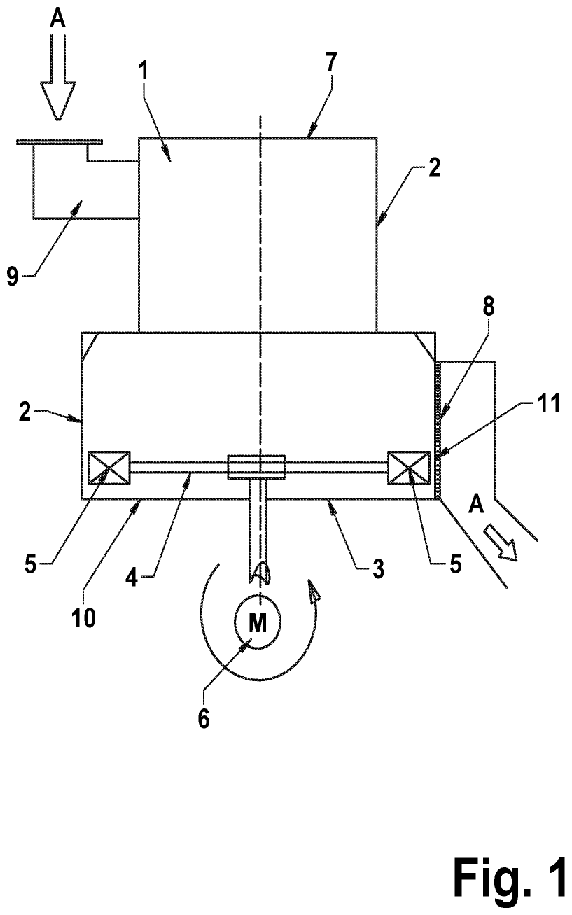

FIG. 1 an impact reactor for carrying out the method in accordance with the invention.

FIG. 1 shows an impact reactor 1, or an impact reactor arrangement for comminuting items which contain fibre composite material.

The starting material is e.g. rotor blades of wind turbine installations which comprise structural components in the form of embedded profiles made of fibre composite material made from carbon fibres. Such rotor blades can have a length of 60 m. In order for the material to be able to be supplied to the impact reactor 1, pre-comminution of the rotor blades is first carried out, in which block-like items are produced. The pre-comminution is effected by sawing.

Prior to comminution, the starting product has about 35 wt. % of matrix and 65 wt. % of fibre material in the form of carbon fibres. The matrix consists of thermosetting synthetic resin and forms a strong composite with the carbon fibres.

The impact reactor 1 comprises a floor 10 and a cylindrical casing 2 made from metallic material. A rotor 3 which is provided with impact elements 5 is arranged in the floor region, in the interior of the casing 2. The rotor 3 is operatively connected to an electric motor 6 which is arranged outside the casing 2. The shaft connecting the rotor 3 to the electric motor 6 extends in the axial direction of the cylindrical casing 2. The rotor 3 is provided with blades 4 which protrude radially from the shaft. Impact elements 5 are disposed at the ends of the free blades 4. The impact elements 5 are interchangeably fastened to the blades 4.

On the end face facing away from the rotor, the impact reactor 1 is closed with a cover 7 so that the floor 10, casing 2 and cover 7 enclose an impact reactor chamber. The cover 7 has a filling opening 9 for introducing the items. At the level of the rotor 3, the casing 2 is further provided with an ejection opening 8 for discharging the comminution products. Perforated cover plates 11 are inserted into the ejection opening 8. The cover plates 11 form screens which comminution products of the desired particle size pass through.

For comminution purposes, the pre-comminuted items are fed into the impact reactor chamber via the filling opening 9. Under the action of the rotor 3 provided with the impact elements 5 the items are comminuted to form comminution products in the form of fibre needles and discharged from the impact reactor chamber via the ejection opening 8. The removal of the comminution product from the impact reactor chamber takes place continually in the present embodiment. The fibre needles are thus discharged immediately after the desired fibre length is achieved.

Alternatively, the ejection opening can also be closable by a flap and so the device is also suitable for batch-wise operation.

The comminution products in the form of fibre needles have a fibre length of 0.1 mm to 10 mm. The fibre needles consist of a fibre material and matrix adhering to the fibre material. The fibre material in turn consists of fibre bundles and of size, which permits firm adhesion of the matrix to the fibre material. In this respect, the fibre needles are still a composite material made from fibre material and matrix. The fibre material is embedded into the matrix, wherein, by reason of comminution, the fibre needles have sharp-edged and irregular break edges, which improves the adhesion of new matrix.

After the comminution in the impact reactor 1, a mesh analysis is carried out using a fraction of fibre needles and a grading curve is determined. In this way the fibre length distribution of the fraction is known and, by mixing different fractions, a mixture of fibre needles with a preset fibre length distribution can be produced. The mesh analysis is carried out by screening the fibre needles in screens of decreasing mesh width.

In order to produce new moulded parts, fibre needles with a desired fibre length distribution are mixed with new matrix in a stirrer. The new matrix preferably consists of thermoplastic resin. After mixing, forming in a press is carried out. Heat can be supplied in so doing. After hardening of the new matrix, the new moulded part is formed.

The method is suitable in particular for producing sheet goods, profiles or three-dimensional moulded parts with a fibre composite made of reprocessed fibre needles. The moulded body newly produced from the comminuted fibre needles has a total of 50 wt. % of matrix. The quantity of the newly added matrix amounts to merely 15 wt. %. The quantity of the fibre portion amounts to 50 wt. %. The fibre lengths of the fibre needles used in this case amount to 1 mm to 10 mm.

The moulded body can also be formed as a multi-layer body. In that case, at least one layer comprises fibre needles. The moulded body can be formed as a sandwich and comprise, in addition to layers of fibre needles, further layers of fibre material, e.g. in the form of a textile. The layer of fibre needles can form a middle layer. A moulded body of this type has a particularly high level of strength and good visual appearance.

It is also advantageous that a moulded body with fibre needles produced in accordance with the invention can be sent again for reprocessing.

The fibre needles can also form an additive in elastomeric articles e.g. in rubber articles such as tyres and the like.

1. A method of reprocessing fibre fiber composite materials, the method comprising:
feeding items containing fiber composite material into an impact reactor; and
comminuting the items by mechanical loading, wherein the comminution is carried out in such a way that fiber needles with adhering matrix are produced as a comminution product.

2. The method according to claim 1, wherein said comminution product contains fiber needles with a fiber length of 0.1 mm to 20 mm.

3. The method according to claim 1, wherein a grading curve is determined in relation to a quantity of the comminution product by using a mesh analysis.

4. The method according to, claim 1, wherein said comminution product is discharged from said impact reactor continuously.

5. The method according to claim 1, wherein said impact reactor has ejection openings.

6. The method according to claim 5, wherein said ejection openings are covered with slotted or perforated cover plates

7. The method according to, claim 1, wherein said fiber composite materials contain at least one of glass fibers, carbon fibers, basalt fibers and aramid fibers.

8. The method according to, claim 1, wherein said comminution product contains carbon fibers with adhering finish and adhering matrix.

9. The method according to claim 1, wherein the items are sent for pre-comminution prior to comminution in said impact reactor.

10. The method according to claim 1, wherein said comminution product is mixed with a new matrix and processed to form molded parts.

11. A molded body compromising fiber needles which can be obtained by the method according to claim 1, and matrix.

12. A method of reprocessing fiber composite materials, comprising:
placing structural components comprising fibers and a matrix into an impact reactor;
mechanically degrading the structural components into a comminuted product in the form of fiber needles with adhering matrix;
determining the size of said comminuted product with at least one of a slotted and perforated cover plates;
discharging said comminuted product out of said impact reactor wherein the size of said comminuted product is adjustable to maximize the fiber needles and adhering matrix ratio.

13. The method of claim 12 further comprising classifying the comminuted product with a classifying device having screens of decreasing mesh width to sort said comminuted product according to a fiber length.

14. The method of claim 12, wherein said comminuted product comprises fibers consisting of a fiber material and a matrix adhering to said fiber material.

15. The method of claim 14, wherein said fiber needles are embedded into the matrix wherein said fiber material has edges with an irregular shape.

16. The method of claim 12, further comprising mixing a new matrix with the comminuted product to produce new molded parts.

17. The method of claim 12 further compromising molding of a new product by mixing of fractions of said commination product with a new matrix wherein said new product has uniform product properties consistent with said structural components prior to reprocessing.

18. The method of claim 17, wherein the mixing step is accomplished by using a stirrer or a mixer.

19. The method of claim 12, wherein a new molded part made from said comminuted product has an average matrix weight of about 50%.

20. A method of reprocessing fiber composite materials, comprising:
placing structural components into an impact reactor;
mechanically degrading the components into a comminuted product in form of fiber needles with adhering matrix;
determining the size of said comminuted product with at least one of slotted and perforated cover plates;
discharging said comminuted product out of said impact reactor wherein the size of said comminuted product is adjustable to maximize the fiber needles and adhering matrix ratio;
reprocessing said comminuted product into a new material with added matrix of less than 15% of total weight.
